(19) United States
(12) Patent Application Publication
(10) Pub. No.: US 2014/0180845 A1
(43) Pub. Date: Jun. 26, 2014

(54) SYSTEM AND METHOD FOR DISPLAY AND DISTRIBUTION OF A PET MEMORIAL

(71) Applicant: Christopher ABARBANEL, Ottawa (CA)

(72) Inventor: Christopher ABARBANEL, Ottawa (CA)

(21) Appl. No.: 14/047,454

(22) Filed: Oct. 7, 2013

Related U.S. Application Data
(60) Provisional application No. 61/739,898, filed on Dec. 20, 2012.

(51) Int. Cl. G06Q 30/02

(52) U.S. Cl. CPC G06Q 30/0277
USPC 705/14.73

(57) ABSTRACT

A system and method for online marketing a pet death care provider comprising providing an online pet memorial on the website of a pet death care provider.

### FIELD OF THE INVENTION

The present invention pertains to a system and method for distribution of online pet memorials. More particularly, the present invention pertains to a system and method for online marketing of pet death care providers.

### BACKGROUND

The Internet is very different than a traditional retail business. In traditional retail business one can create a great looking store and reap the benefits by getting foot traffic to come into the store. In an Internet environment, you can build the nicest looking store front/website but users will not visit unless they have a reason to do so. Bricks and mortar marketing strategies do not translate in the online business environment. Companies spend millions of dollars every year on internet marketing strategies to drive traffic to then respects website.

Social media has become integral to the success of a business' overall strategy (Qualman Erik, Socialnomics: How Social Media transforms the way we Live and do Business, 2010, John Wiley and Sons, pages 1344, incorporated herein by reference). An example of social media increasing business revenue is the Ford Fiesta Movement. 100 Fiestas were given to digital influencers for six months; they engaged in the following social media activities: tweeting, blogging, pasting videos and photos and writing about their experience. This content was connected to the Ford site and the results were impressive: 11,000 vehicle reservations, and an awareness of 60 percent—equal to that of vehicles that have been in the market for two or three years.

The purpose of a corporate website is simple: market and promote the corporate brand and generate new revenues via new client acquisition. Word of mouth marketing has become an over-riding preoccupation for marketers as it provides a good measure of success, if customers endorse brands to their peers. (Smith, P. R., Ze Zook. Marketing Communications: Integrating Offline and Online with Social Media, 5^{th} Edition, 2011, Kogan Page Limited, pages 5-6, incorporated herein by reference.)

In 2009 in the United States, companies spent $22.7 billion on website and brand marketing according to PricewaterhouseCoopers (PwC) [http://www.iab.net/media/file/IAB-Ad-Revenue-Full-Year-2009.pdf]. Based on industry data from PwC from 2005 to 2009, in five key U.S. ad-supported media (television, radio, newspapers, consumers magazines and Internet) the Internet's share of combined ad revenue grew from 8% to 17%.

Traditional website marketing strategy is based in principle on two practices: the marketing of the domain and its' promotion on multiple Internet search engines such as, for example Google, Yahoo and Bing. This website marketing approach often focuses on building product and service web pages, industry accolades and press releases to draw internet users to their website. Search engine marketing is the practice of promoting a website on the multiple Internet search engines and portals. This is achieved by ensuring that the domain website has been sufficiently accessed (hits) or that the content being searched upon is unique to the company's domain so that it is within the first page results of a relevant search.

A third and the most recent website marketing strategy is Web 2.0, which is a social interaction website marketing strategy. Although a relatively new website marketing strategy, it is proving to be highly effective in driving traffic to the domain website (e.g. www.arbormemorial.com). With Web 2.0, current and prospective customers are able to share information and communicate using web tools. This is accomplished through social interaction such as website messaging, forums, blogs, and podcasts for all Internet users with novice technical expertise. A domain website gains significant Internet traffic by attracting consumers through social interaction.

Based on information collected from PermaVita (an online memorial for humans), there are on average 70 unique visitors per memorial site. The top 10% of the memorial sites average close to 1000 unique visitors per memorial site. Visitors have increased revenue generated online because visiting this online memorial content has led to these visitors purchasing ancillary products such as keepsake books, online memorial extensions and DVDs. Keepsake book sales occur for approximately 9% of all sites, online extensions occur for approximately 6% of all sites, and DVD purchases occur for roughly 18% of all sites created. Lastly, companies who have an online relationship with the funeral homes, such as flower companies, have experienced up to a 200% increase in online flower purchases as a direct result of these online memorial sites being linked to funeral home providers.

There currently exists free online memorial websites for pets; however, they are hosted by non-pet death care websites and do not drive traffic to the website of pet death care providers and thus revenue for pet death care organizations. The website of a pet death care provider can be as vehicle for the promotion of its corporate image, products and services. The website serves to strengthen the company's position in the marketplace, enhance its corporate image, and fortify its brand recognition among others. There remains a need in the marketplace of the pet death care provider industry to combine a website marketing strategy with online memorials for pets.

This background information is provided for the purpose of making known information believed by the applicant to be of possible relevance to the present invention. No admission is necessarily intended, nor should be construed, that any of the preceding information constitutes prior art against the present invention.

### SUMMARY OF THE INVENTION

An object of the present invention is to provide a system and method for online marketing a pet death care provider comprising providing an online pet memorial on the website of a pet death care provider.

In accordance with one aspect, there is provided a computer-implemented method for online marketing a pet death care provider, the method comprising: inputting user-provided information to a computer to create an online recordation, wherein the user-provided information comprises digital media content about a deceased pet, organizing the online recordation to create an online pet memorial; hosting the online pet memorial on a server; and displaying the online pet memorial on the website of the pet death care provider, wherein online access to the online pet memorial on the server is obtained through the website of the death care provider.

In accordance with one embodiment, the memorial, comprises a plurality of recordations, each recordation comprising digital media content relating to the deceased pet.

In accordance with another embodiment, the digital media content is one or more of text, documents, images, photograph, photograph slideshow, video recording, audio recording, stationary graphics, animated graphics, and music.

In accordance with another embodiment, the deceased pet is a cat or dog.

In accordance with another embodiment, the memorial is accessible for a fixed period of time.

In accordance with another embodiment, the method increases traffic to the website of the pet death care provider.

In accordance with another embodiment, the pet death care provider is a veterinary clinic, vet hospice, euthanizer, mobile vet hospice, mobile euthanizer, pet insurance provider, pet crematorium or pet cemetery.

In accordance with another aspect, there is provided an interactive graphical user interface on a computer system for presenting a pet memorial for a deceased pet, the graphical user interface comprising:
a) a viewable screen image associated with the deceased pet;
b) at least one recordation associated with the deceased pet; and
c) an identification field to identify a pet death care provider.

The interactive graphical user interface of claim 8, further comprising a plurality of selection options on the viewable screen image, each of said selection options corresponding to the at least one recordation such that when a selection option is selected, the corresponding recordation is presented.

In accordance with one embodiment, the at least one recordation comprises digital media content selected from one or more of text, documents, images, photograph, photograph slideshow, video recording, audio recording, stationary graphics, animated graphics, and music.

In accordance with another embodiment, the interactive graphical user interface further comprises background music.

In accordance with another embodiment, the deceased pet is a dog or cat.

In accordance with another embodiment, the pet death care provider is a veterinary clinic, vet hospice, euthanizer, mobile vet hospice, mobile euthanizer, pet insurance provider, pet crematorium or pet cemetery.

In accordance with another aspect, there is provided a method for providing an online memorial for a deceased pet, the method comprising the steps of:
a) providing access, to a customer, to an online pet memorial website;
b) collecting, from the customer, digital media content pertaining to a deceased pet;
c) organizing the digital media content into at least one recordation;
c) storing the at least one recordation on a computer readable medium; and
d) displaying the online pet memorial with the at least one recordation and an identification of a pet death care provider on a website.

In accordance with one embodiment, the method further comprises displaying the online pet memorial further comprises displaying a plurality of selection options on the viewable screen image, each of said selection options corresponding to one of the at least one recordation such that when a selection option is selected, the corresponding recordation is presented.

In accordance with another embodiment, the digital media content selected from one or more of text, documents, images, photograph, photograph slideshow, video recording, audio recording, stationary graphics, animated graphics, and music.

In accordance with another embodiment, the step of providing access to the memorial comprises subscription by the customer.

In accordance with another embodiment, the step of displaying the pet memorial is for a fixed or indefinite period of time.

In accordance with another embodiment, the fixed period of time is extendable by the customer and/or the pet death care provider.

In accordance with another embodiment, the pet death care provider is a veterinary clinic, vet hospice, euthanizer, mobile vet hospice, mobile euthanizer, pet insurance provider, pet crematorium or pet cemetery.

In accordance with another aspect, there is provided a graphical user interface for displaying a pet memorial for a deceased pet on the website of a pet death care provider, the graphical user interface comprising:
a) at least one recordation relating to the deceased pet; and
b) at least one viewable screen associated with at least one recordation, the at least one viewable screen comprising an identification field for a pet death care provider.

In accordance with one embodiment, the graphical user interface comprises multiple viewable screens, wherein one of the at least one viewable screens is a main viewable screen.

In accordance with another embodiment, the main viewable screen comprises a plurality of selectable options each corresponding to at least one recordation, said selectable options operative to display the viewable screen corresponding to the at least one recordation when the corresponding selectable option is selected.

In accordance with another embodiment, the at least one recordation comprises online media content selected from one or more of text, documents, images, photograph, photograph slideshow, video recording, audio recording, stationary graphics, animated graphics, and music.

In accordance with another embodiment, the pet death care provider is a veterinary clinic, vet hospice, euthanizer, mobile vet hospice, mobile euthanizer, pet insurance provider, pet crematorium or pet cemetery.

In accordance with another aspect, there is provided an interactive user interface on a computer system for presenting a pet memorial for a deceased pet, the user interface comprising:
a) as viewable screen image associated with the deceased pet, the at least one viewable screen comprising an identification field for a pet death care provider;
b) at least one recordation related to the deceased pet;

In accordance with one embodiment, the interactive user interface further comprises a plurality of selection options on the viewable screen image, each of said selection options corresponding to the at least one recordation such that when a selection option is selected the corresponding at least one recordations is presented.

In accordance with another aspect, there is provided a computer implemented system for online marketing of a pet death care provider comprising:
a first computer readable storage medium for providing online a website for the pet death care provider; and
a second computer readable storage medium in electronic communication with the first computer readable storage medium for hosting online a pet memorial on the website of the pet death care provider.

In accordance with one embodiment, the system increases traffic to the website of the pet death care provider.

In accordance with another embodiment, the second computer readable storage medium hosts a plurality of pet memorials.

In accordance with another embodiment, the second computer readable storage medium is in electronic communication with more than one first computer readable storage mediums for hosting a plurality of pet memorials on a plurality of pet death care provider websites.

In accordance with another embodiment, the online memorial includes at least one recordation comprising digital media content selected from one or more of text, documents, images, photograph, photograph slideshow, video recording, audio recording, stationary graphics, animated graphics, and music.

In accordance with another embodiment, the pet death care provider is a veterinary clinic, vet hospice, euthanizer, mobile vet hospice, mobile euthanizer, pet insurance provider, pet crematorium or pet cemetery.

### BRIEF DESCRIPTION OF THE FIGURES

For a better understanding of the present invention, as well as other aspects and further features thereof, reference is made to the following description which is to be used in conjunction with the accompanying drawings, where:

FIG. 1 is a schematic depiction of an example layout for the online pet memorial;

FIG. 2 is an exemplary identification field identifying the pet death care provider alongside a photograph and identification of a deceased pet;

FIG. 3 is an exemplary list of recordations available on the online pet memorial, with an additional photograph of the deceased pet and associated text;

FIGS. 4A-4E are various recordations that can be available on the pet memorial, wherein 4A is an obituary for an obituary recordation, 4B is a list of favorites for a favorites recordation, 4C is an example of a story posted by a visitor to the pet memorial fur a story recordation, 4D are guestbook entries for a guestbook recordation, and 4E is a list of charities for a donation recordation;

FIG. 5 depicts an exemplary pet death care provider administration login to activate a memorial site for their customer;

FIG. 6 depicts an exemplary customer interface for the online pet memorial; and

FIG. 7 depicts and exemplary quick start login for creating the online pet memorial.

### DETAILED DESCRIPTION OF THE INVENTION

Definitions

Unless defined otherwise, all technical and scientific terms used herein have the same meaning as commonly understood by one of ordinary skill in the art to which this invention belongs.

As used in the specification and claims, the singular forms “a”, “an” and “the” include plural references unless the context clearly dictates otherwise.

The term “comprising” as used herein will be understood to mean that the list following is non-exhaustive and may or may not include any other additional suitable items, for example one or more further feature(s), component(s) and/or element(s) as appropriate.

As used herein, the term “pet death care provider” refers to any individual or organization involved in providing care, support (financial or emotional) or compensation to pets and/or the pet owner around the time of death of the pet. This term includes but is not limited to veterinarian clinics, vet hospices, euthanizers, mobile vet hospices, mobile euthanizers, pet insurance providers, pet crematoriums and pet cemeteries. The pet death care provider is also the preferred distribution channel for the presently described online pet memorial.

As used herein, the term “customer” refers to the person or group of people who add content to the online pet memorial. The customer can include the owner of the deceased pet, or family or friends thereof.

As used herein, the term “pet” refers to any animal cared for by a human. Such an animal can have their primary habitation indoors with a human, or may live primarily outdoors, such as in a barn or animal habitat. Some non-limiting examples of pets are dogs, cats, rabbits, birds, reptiles, monkeys, chimpanzees, ferrets, pigs, horses, donkeys, llamas, ponies, guinea pigs, and hamsters.

As used herein, the term “digital media” includes any type of communication that can be made available online by a computer. These include but are not limited to text, documents, images, photograph, photograph slideshow, video recording, audio recording, stationary graphics, animated graphics, and music.

### Distribution of Online Pet Memorials

The present system and method provides incentive for new users to visit the website of a pet death care provider through the hosting of an online pet memorial.

The animal death care industry has numerous distribution channels. These can include, but are not limited to: animal and/or pet cemeteries, mobile euthanizing clinics, mobile pet death care providers, pet insurance companies, veterinarian clinics, and pet crematoriums, pet grooming stores/spas, and other animal euthanizers. These distribution channels will distribute our pet online memorial software product to solve the problem of their website marketing strategy. This approach fills a void in the market by increasing pet death care provider website traffic which can result in an increase in business revenue. This is applicable to all of the distribution channels mentioned above.

Specifically, the presence of the pet memorial offers a reason for intern users to visit the websites of the per death care provider and can thus increase internet traffic to the website. Internet users come to the websites of the pet death care providers and consequently increase business revenues for players in the pet death care industry.

Marketing

Pet death care providers have a valuable and unique website marketing strategy advantage in the offering of online memorials and obituaries. These tributes and biographies can attract internet users from around the world to their website without the need to spend on website marketing strategies. Social media through the online pet memorial can direct traffic via providing access to information that is otherwise unavailable. Content created by customers to create the online pet memorial has wide reach based on the dissemination of the online pet memorial website address to a plurality of internet users through customer address books and contacts. This is an invaluable asset to pet death care providers and has enormous potential in driving ancillary website revenues and enhancing brand recognition.

The present system and method can provide an improved website marketing strategy for pet death care providers. Having a pet memorial reside on the pet death care provider's website will give a reason for unique visitors to visit the company's website. Housing a socially interactive component on the company website is what will attract the visitors who will subsequently engage in the online memorial and drive revenues. A quick response (QR) code can also be placed on an urn, tombstone, or any other pet death memorabilia, can also be scanned to immediately direct the mobile surfer to the online pet memorial through the website of the pet death care provider.

There are two significant factors to a successful and vibrant website marketing strategy: (1) the pet death care provider must be the single source of its content, and (2) it is not enough to simply own one's content but also to have content which is considered valuable to many and is consistently sought after, driving internet traffic to the website. To fulfill this strategy, the per death care provider can implement a straightforward architecture whereby it integrates and hosts, internal to it's own web environment, an online obituary or memorial tool The data and content are thereby secured within its domain, and not propagated throughout the internet.

The online pet memorial will preferably be hosted by or linked from the website of the pet death care provider so that unique visitors will have an incentive to visit the website of the pet death care provider. This can be accomplished either by hosting the online memorial database on the server of the pet death care provider, or by providing a link from the website of the pet death care provider to a memorial hosting server which can customize the online pet memorial for the pet death care provider.

A model similar to that of the presently described system and method has proven successful in the human side of the death care industry. Funeral homes using a similar system for displaying online memorials have indicated a surge in their revenue as a result of the product generating website traffic. Specifically, the number of unique visitors has increased, ancillary product purchase has increased revenue, and external companies who have relationships with funeral homes have seen an increase in their business as a direct result of the online memorial sites. The following are monetary statistics that pertain to a funeral home operator who is partnered with the Applicant for hosting online human memorials, extrapolated from 3 months of results to date as of December 2012:
$1.962 million per year in additional revenues from selling online human memorials (18.000 memorials*$109 (markup from wholesale price))
$400,500 from DVD sales (18% of 18,000*$125 (Average DVD retail price))
$119880 from Keepsake Books (9% of 18,000*$74 (markup from wholesale price))
$117,700 from Online Extensions (6% of 18,000*$109 (average markup from wholesale price for 1-year extension))

Printed or promotional material can be provided by the pet death care provider to potential customers. The printed or promotional material can include but is not limited to pamphlets, cards, folders, posters, electronic displays, email distribution, sympathy notes, activation documents, or promotion on the pet death care provider website. The printed or promotional material can also include a quick response (QR) code to fatly capture the benefits of an effective online website marketing strategy, specifically the inclusion of social media. The QR code can also reach the mobile demographic of the online market.

Revenue

Revenue can be generated for the pet death care provider in various ways via the online pet memorial. Immediate revenues generated by the sale of the online memorial product and by internet customers purchasing products and services directly from pet death care providers or through contact information. Other revenue streams can include providing a pet memorial service to a client separately, or bundled with other services provided by the pet death care provider.

Future revenues can also be generated by gathering visiting customer information. This permits companies to reach back to potential customers and gain new clients. Sales lead generation can be accomplished throng the acquisition of email addresses, phone numbers, home addresses, and cookies that enable the collection of prospective customer information. Long-term revenue generation can also be obtained through new client registration as a direct result from increased exposure of the pet death care provider to theft target demographic: pet owners.

Account activation can be made available by the pet death care provider for the customer to enable the customer to create the online pet memorial and provide access to the online pet memorial for a period of time. The account can either be free of charge to the customer or can require payment by the customer, depending on the agreement between the hosting company and the pet death care provider. The period of time of the subscription can be fixed, or indefinite, depending on any agreement between the pet death care provider, customer, and/or hosting company. Online access to the pet memorial can also be extended by enabling the customer and/or the pet death care provider to lengthen the period of time for online access. The customer can also be given the opportunity to pay a fee to have the account extended for the customer's preferred period of time.

Advertising on the website can be another source of revenue for the pet death care provider. Advertising can either be sold by the pet death care provider per advertisement, or the pet death care provider can arrange with an advertiser to take a percentage of future sales of the advertiser product or service based on referrals from the website. Advertising can take the form of banner ads, links, coupons, videos, or any other form available online. Contacting the customer by electronic mail is also a possible form of advertising, as contact information is required to activate the account. Further, there can be other opportunities for advertising on email reminders for website account expiry.

The pet death care provider can also take advantage of increased traffic to the website by promoting its own products and services. This can increase sales directly to the pet death care provider. Additionally, products and services related to the death of the pet can be provided by the pet death care provider, such as additional memorial objects, flowers, cards, and other products that may be purchased by visitors to the online pet memorial.

Online Pet Memorial

A customer can create a loving tribute to a deceased pet including digital media comprising one or more of photos, videos, music, documents, stories, timelines and favorite memories of family and friends. Software provided to the customer will be easy to use, such that no computer programming or website experience is needed for the customer to create the online pet memorial. Online help and tutorials can also be provided to assist the customer through the creation and editing of the online pet memorial. A ‘Getting Started’ user guide can also be provided and easily accessible on all customer's memorial sites to assist customers in getting started.

The online memorial can include one or more memorial elements or recordation to share the life of a pet via the online interaction of the client with their contacts, as described below. The online memorial can also have a section for sharing condolences so that friends and family can share a memory of the customer's deceased pet and offer words of support during a difficult time.

In use, a client can subscribe to or purchase an online memorial for their deceased pet from a pet death care provider. The client can add various memorial elements in the form of digital media as desired to the online memorial. These memorial elements can include photographs, a photo album, biography, favorites, eulogy, a life story, video, or music. The online memorial can also include fields for donations.

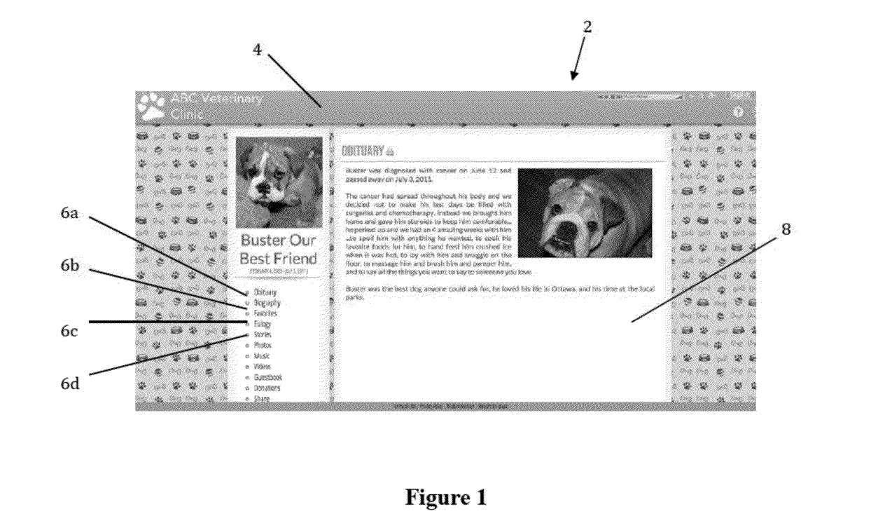

The online memorial can also have many templates from which the customer can choose. Each template can include, for example, different backgrounds, buttons, colors, fonts, displays, images, and effects, to enable the customer to customize their online pet memorial. By way of example, some specific templates are: yellow bones, brown paw prints, grey cat, green-general, etc. An example ‘yellow bones’ background is shown in FIG. 1.

Access to the online pet memorial can be restricted as desired by the customer. Access options can include, but are not limited to: the customer only, the customer and selected family and friends; or public access. The privacy settings of the online pet memorial are selected by the customer and/or the pet death care provider. In addition, customer can have the option to to set up editing privileges to multiple users. By way of example, editing privileges enables an individual to post content on all aspects and/or features of the memorial site. Furthermore, customers can use the privacy settings to ensure that all external content is approved by the customer before appearing on the memorial site.

Identification Field

The online pet memorial comprises a plurality of customizable fields. To achieve the business strategies as described above, an identification field to identify the pet death care provider will be provided on the online pet memorial. The identification field can include a logo, photograph, text, as well as contact information for the pet death provider, such as address, phone number or combination thereof, to identify the pet death care provider. The identification field can be a banner, sidebar, background, or occupy any other place on the web page of the online pet memorial as desired by the pet death care provider.

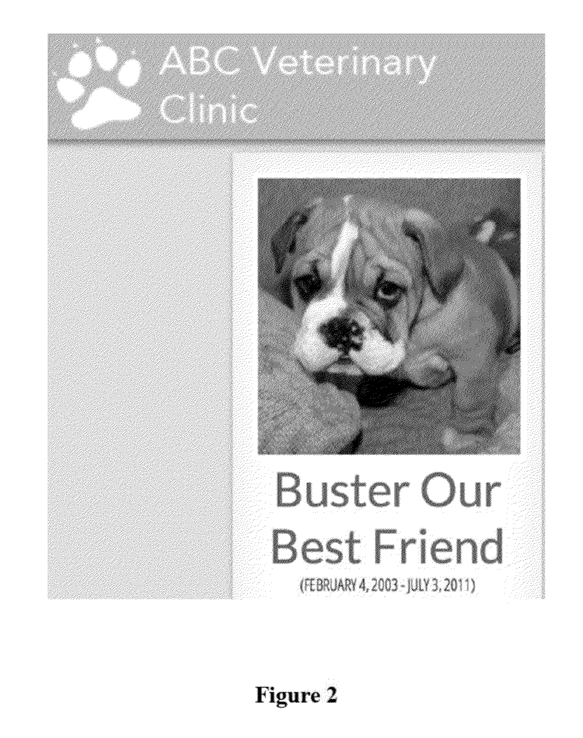

Referring to FIG. 1, an exemplary online pet memorial is shown. The pet memorial website (2) comprises an identification field (4) to identify the pet death care provider. As discussed above, this provides exposure of the pet death care provider to visitors of the memorial website. FIG. 2 shows one example of a pet death care identification field at the top of the online pet memorial. In this case, the pet death care provider is the ‘ABC Veterinary Clinic’. A photograph of the deceased pet and information about the pet is also shown.

Recordations

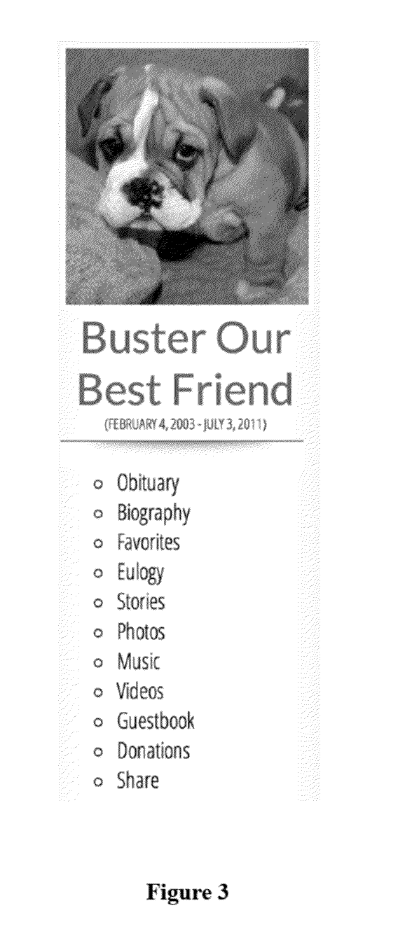

Links to recordations are provided on the website to enable customers to create and add content to the pet memorial. The recordations can include but are not limited to: obituary; biography; favorites; eulogy; stories; photos; music; videos; guestbook; donations and share. Links to some or all of the available recordations can be provided on the website depending on the customer. The website shown in FIG. 1 also includes links to a plurality of recordations (6a, 6b, 6c, 6d). The displayed recordation (8) selected from the links is shown in the main part of the online memorial. The customer can add content to one or more recordation in the pet memorial. FIG. 3 shows a section of the pet memorial having a photograph of the deceased pet with links to the recordations.

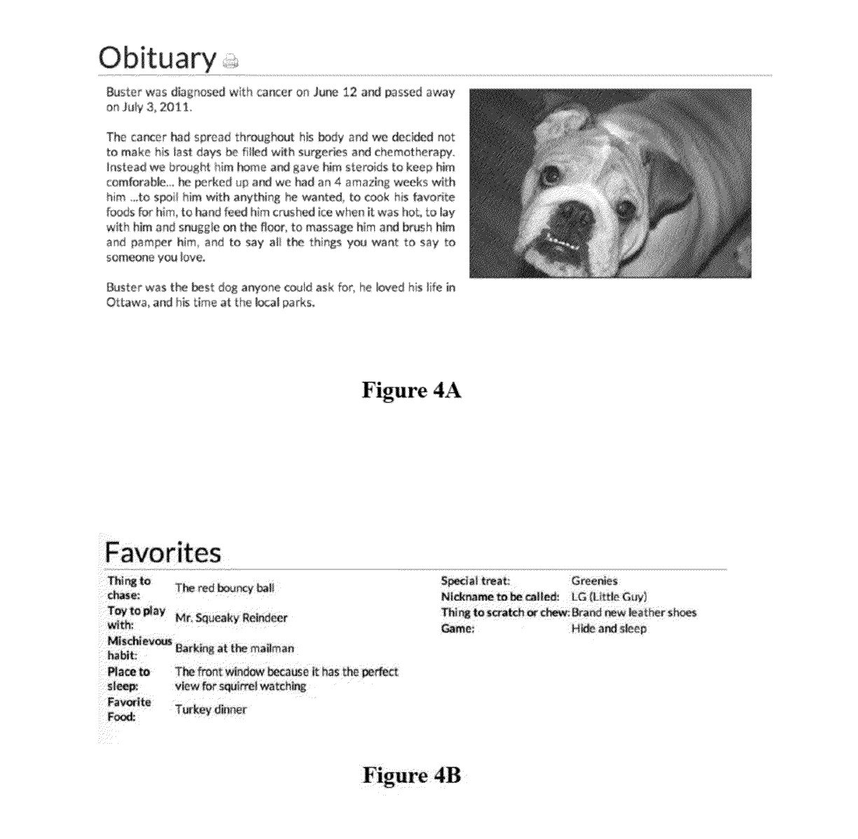

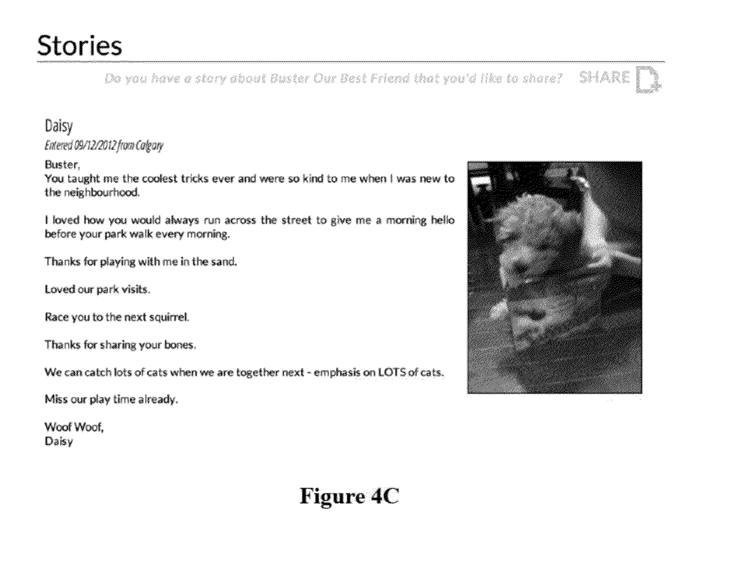

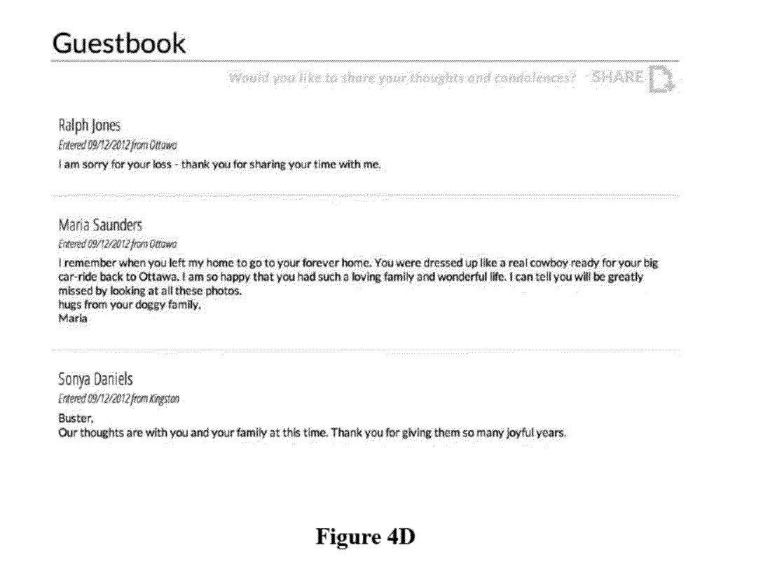

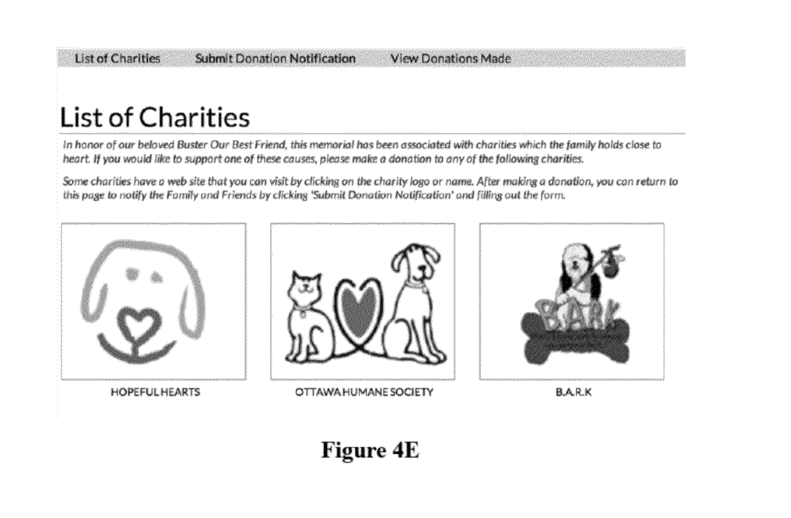

The ‘obituary’, ‘eulogy’ and ‘biography’ recordations can include text provided by the customer. These recordations can also include any digital media, as previously defined. One example of an obituary for an obituary recordation is shown in FIG. 4A

The ‘favorites’ recordation allow customers to fill in brief answers to provided questions about their deceased pet. The questions and the answers can then be displayed in the favorites recordation. Non-limiting examples of questions that can be asked to customers about their deceased pet are ‘what was your pet's favorite . . . ’: to chase; toy to play with mischievous habit; place to sleep; food; special treat; nickname to be called: thing to scratch or chew; and game. Customers can fill out none, some, or all of the questions provided, and questions with answers will be displayed in the in the favorites recordation. FIG. 4B shows an example of a list of favorites for a favorites recordation. There can also be open-ended ‘favourite’ recordations provided to the customer. This open-ended field can enable the customer to share any additional ‘favourite’ information they deem appropriate to share.

The ‘story’ recordation can include text provided by the customer or by visitors to the pet memorial. These recordations can also include any digital media, as previously defined. FIG. 4C is an example ‘story’ recordation comprising a story with an accompanying photograph posted by a visitor to the online pet memorial.

The ‘photos’ recordation can include photographs or images of the deceased pet, friends and/or family of the deceased pet, or any other photographs or images that the customer wishes to put in this recordation. Fields in this recordation can be adapted for download of photographs or images from the customer's computer or electronic device. Also provided can be fields for captioning the photograph or image with text. These photos can also be used to generate a photo album or slide show for visitors to watch on the website.

The ‘music’ recordation can include any music or sound recordings. The ‘videos’ recordation can include any video recordings or animated image. These recordations can also include text provided by the customer, as well as any other digital media, as previously defined.

The ‘guestbook’ recordation can include a format for posting comments from people (commenter) visiting the pet memorial. Comments posted in the guestbook can include one or more of text, photograph(s), video(s) and other digital media. The guestbook can also display information relating to the comment, including but not limited to the name of the commenter, comment date, and commenter location. FIG. 4D shows an exemplary guestbook entry for a guestbook recordation.

The ‘donations’ recordation can include a list of charities. The list of charities can be selected by the customer and/or pet death care provider, or be selected from a list provided by the memorial hosting company. Customers can also add the name of a charity that they wish to receive donations on behalf of their deceased pet. Means for making a donation to a charity can also be provided in the donations recordation. Other information in the donations recordation can include one or more links to charity websites, a description of the charity, image, logo, or trademark of the charity. FIG. 4E is an exemplary donation recordation including a list of charities with associated graphics, names of the charities, and links to the charities. A single link to a charity selected by the customer and/or pet death care provider can also be displayed.

Further, a ‘documents’ recordation can be provided so that documents such as, for example, medical records, breeding contracts, birth certification, genetics, pedigree document, breeder registration and/or breeder standing with a Kennel Club, awards and certificates for shows, breed standard document, or breed authentication certificates can be stored and/or available for display and/or download on the online pet memorial.

Keepsakes

The online pet memorial can also optionally include means to order a keepsake of the deceased pet. The keepsake book can incorporate some or all of the content added by the customer to the online pet memorial to create a hardcopy or electronic stand-alone product that can be ordered and delivered to the customer. The keepsake book can either be purchased when the account is activated, or purchased at a later date. The keepsake book can then be mailed to the customer, or any other address that the customer provides upon confirming the book order.

Non-limiting examples of a keepsake include a book, photograph with optional writing; photograph mosaic; slideshow having video, photographs, text, or a combination thereof. These can be provided in hardcopy or electronic formats, or an of these can be electronically provided via memory means such as a flash drive, DVD, CD, or by download. Any or all of the memorial content can be reformatted to accommodate the desired keepsake format.

One particular keepsake that can be available is a keepsake memorial book which can transform an online memorial into a physical heirloom. The keepsake memorial book can incorporate any or all contributions made to the online memorial website, including those made by the customer, other users with editing privileges, as well as from visitors to the online memorial. Ordering of a keepsake books can provide a hardcopy format to share and store the unique memories of a loved pet. The keepsake book can be hardcover-bound and printed on photo quality paper. A selection of cover options and colors can be made available to the customer, and an online preview option can enable the customer to assemble and/or view the entire keepsake book before ordering.

Other keepsakes can include memorial objects which can be offered to customers to memorialize their pets. A memorial object can have one or more of a photograph, birth date, death date, pet name, phrase, or any other printable media desired by the customer. Some examples memorial objects include but are not limited to: jewellery, keychains, plaques, charms, urns and photo frames.

Distribution/Activation Method

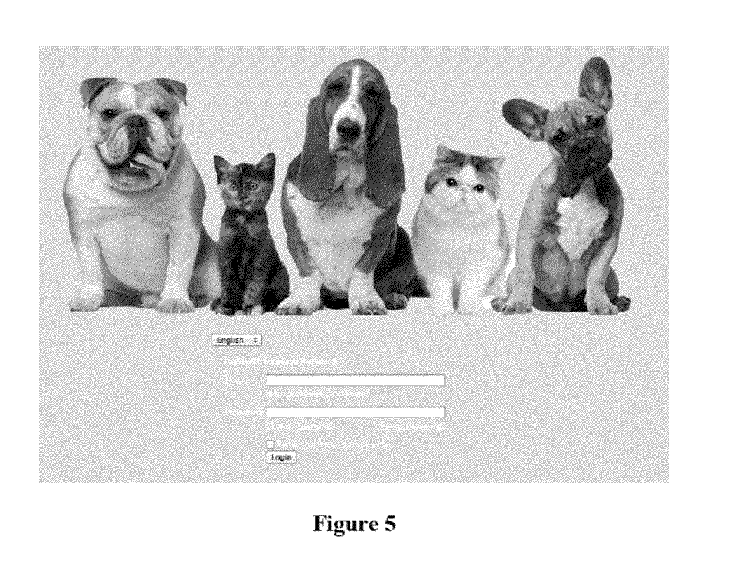

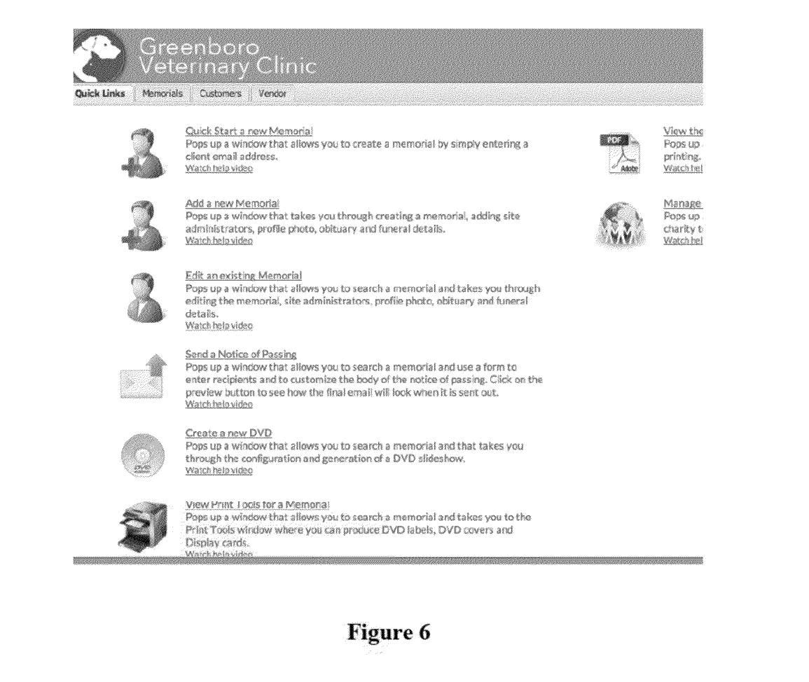

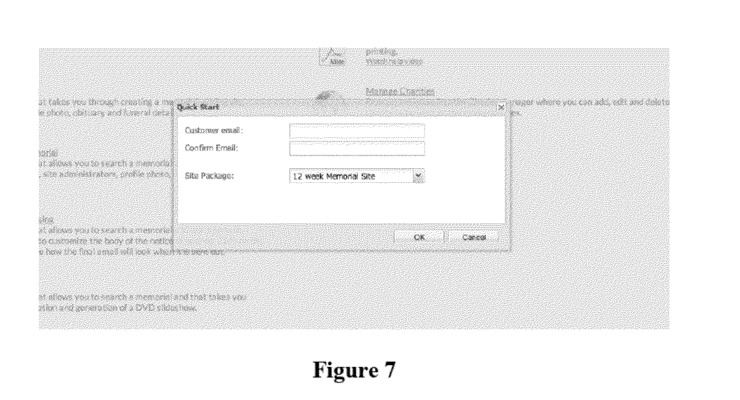

The software system can be set up to activate an account upon the command of the pet death care provider. The account can be activated at any point in the pet's life, or upon its death. An email notification can be sent to the customer by the pet death care provider, welcoming them to their online memorial website for their pet. The pet death care provider can accomplish this by selecting the appropriate online memorial package and sending an email to the customer. FIGS. 5-7 show an exemplary customer login to activate a memorial, an exemplary customer interface, and an exemplary quick start login, respectively. The customer can then navigate to their unique online memorial URL in the email to begin contributing to the online pet memorial. In one embodiment, the online memorial is not activated until the customer navigates to the URL provided in the email from the pet death care provider. A second follow-up email can then be sent through the software system to inform the customer of their password and/or username for the online memorial. The client can then login to populate the online pet memorial as desired throughout the duration of their online memorial.

Additional Features

The online pet memorial can also provide a ‘notification of passing card’ or a ‘notification of anniversary card’ in e-mail or print (hardcopy) format so that customers can easily inform fiends and family of the loss of their pet. Clients can send the ‘notification of passing’ card including a link if electronic, or printed link or QR code if hardcopy, to the online pet memorial to their family and animal loving friends. This invites recipients to visit the online pet memorial website, and contribute in sharing stories or media on the online pet memorial. This in turn not only generates website traffic for pet death care providers, but gives them the opportunity to market their products and services to visitors to the pet death care provider website.

Privacy settings can also be made available on the memorial. The customer can be provided with an option to access the security settings on their account and add additional users with editing privileges to the account. Additional users can have the same privileges as the customer, or more limited privileges, based on the desires of the customer. Any user with editing privileges can populate the online pet memorial and/or can invite others to contribute as well.

The pet memorial can also include other fields at the discretion of the pet death care provider and memorial website hoster. These may include links to social media, links to outside services, advertising fields with links, or any other field desired.

Other fields may also available on the pet memorial, such as a photograph of the deceased pet and/or associated text, which may include one or more of the name of the pet, date of birth, date of death, or birthday.

All publications, patents and patent applications mentioned in this Specification are indicative of the level of skill of those skilled in the art to which this invention pertains and are herein incorporated by reference to the same extent as if each individual publication, patent, or patent application was specifically and individually indicated to be incorporated by reference.

The invention being thus described, it will be obvious that the same may he varied in ninny ways. Such variations are not to be regarded as a departure from the spirit and scope of the invention, and all such modifications as would be obvious to one skilled in the art are intended to be included within the scope of the following claims.

1. A computer-implemented method for online marketing a pet death care provider, the method comprising:
inputting, user-provided information to a computer to create an online recordation, wherein the user-provided information comprises digital media content about a deceased pet;
organizing the online recordation to create an online pet memorial;
hosting the online pet memorial on a server; and
displaying the online pet memorial on the website of the pet death care provider,
wherein online access to the online pet memorial on the server is obtained through the website of the death care provider.

2. The method of claim 1, wherein the memorial comprises a plurality of recordations, each recordation comprising digital media content relating, to the deceased pet.

3. The method of claim 1, wherein the digital media content is one or more of text, documents, images, photograph, photograph slideshow, video recording, audio recording, stationary graphics, animated graphics, and music.

4. The method of claim 1, wherein the deceased pet is a cat or dog.

5. The method of claim 1, wherein the memorial is accessible for a fixed period of time.

6. The method of claim 1, wherein the method increases traffic to the website of the pet death care provider.

7. The method of claim 1, wherein the pet death care provider is a veterinary clinic, vet hospice, euthanizer, mobile vet hospice, mobile euthanizer, pet insurance provider, pet crematorium or pet cemetery.

8. An interactive graphical user interface on a computer system for presenting a pet memorial for a deceased pet, the graphical user interface comprising:
a) a viewable screen image associated with the deceased pet;
b) at least one recordation associated with the deceased pet; and
c) an identification field to identify a pet death care provider.

9. The interactive graphical user interface of claim 8, further comprising a plurality of selection options on the viewable screen image, each of said selection options corresponding to the at least one recordation such that when a selection option is selected, the corresponding recordation is presented.

10. The interactive graphical user interface of claim 8, wherein the at least one recordation comprises digital media content selected from one or more of text, documents, images, photograph, photograph slideshow, video recording, audio recording, stationary graphics, animated graphics, and music.

11. The interactive graphical user interface of claim 8, further comprising background music.

12. The interactive graphical user interface of claim 8, wherein the deceased pet is a dog or cat.

13. The interactive graphical user interface of claim 8, wherein the pet death care provider is a veterinary clinic, vet hospice, euthanizer, mobile vet hospice, mobile euthanizer pet insurance provider, pet crematorium or pet cemetery.

14. A method for providing an online memorial for a deceased pet, the method comprising the steps of:
a) providing access, to a customer, to an online pet memorial website;
b) collecting, from the customer, digital media content pertaining to a deceased pet;
c) organizing the digital media content into at least one recordation;
c) storing the at least one recordation on a computer readable medium; and
d) displaying the online pet memorial with the at least one recordation and an identification of a pet death care provider on a website.

15. The method of claim 14, wherein displaying the online pet memorial fin/her comprises displaying a plurality of selection options on the viewable screen image, each of said selection options corresponding to one of the at least one recordation such that when a selection option is selected, the corresponding recordation is presented.

16. The method of claim 14, wherein the digital media content selected from one or more of text, documents, images, photograph, photograph slideshow, video recording, audio recording, stationary graphics, animated graphics, and music.

17. The method of claim 14, wherein providing access to the memorial comprises subscription by the customer.

18. The method of claim 14, wherein displaying the pet memorial is for a fixed or indefinite period of time.

19. The method of claim 18, wherein the fixed period of time is extendable by the customer ardor the pet death care provider.

20. The method of claim 14, wherein the pet death care provider is a veterinary clinic, vet hospice, euthanizer, mobile vet hospice, mobile euthanizer, pet insurance provider, pet crematorium or pet cemetery.

21. A graphical user interface for displaying a pet memorial for a deceased pet on the website of a pet death care provider, the graphical user interface comprising:
a) at least one recordation relating to the deceased pet;
b) at least one viewable screen associated with at least one recordation, the at least one viewable screen comprising an identification field for a pet death care provider.

22. The graphical user interface of claim 21, comprising multiple viewable screens, wherein one of the at least one viewable screens is a main viewable screen.

23. The graphical user interface of claim 22, wherein the main viewable screen comprises a plurality of selectable options each corresponding to at least one recordation, said selectable options operative to display the viewable screen corresponding to the at least one recordation when the corresponding selectable option is selected.

24. The graphical user interface of claim 21, wherein the at least one recordation comprises online media content selected from one or more of text, documents, images, photograph, photograph slide show, video recording, audio recording, stationary graphics, animated graphics, and music.

25. The graphical user interface of claim 21, wherein the pet death care provider is a veterinary clinic, vet hospice, euthanizer, mobile vet hospice, mobile euthanizer, pet insurance provider, pet crematorium or pet cemetery.

26. An interactive user interface on a computer system for presenting a pet memorial for a deceased pet, the user interface comprising:
a) a viewable screen image associated with the deceased pet, the at least one viewable screen comprising an identification field for a pet death care provider; and
b) at least one recordation related to the deceased pet.

27. An interactive user interface of claim 26, further comprising a plurality of selection options on the viewable screen image, each of said selection options corresponding to the at least one recordation such that when a selection option is selected the corresponding at least one recordations is presented.

28. A computer implemented system for online marketing of a pet death care provider comprising:
a first computer readable storage medium for providing online a website for the pet death care provider; and
a second computer readable storage medium in electronic communication with the first computer readable storage medium for hosting online a pet memorial on the website of the pet death care provider.

29. The system of claim 28, wherein the system increases traffic to the website of the pet death care provider.

30. The system of claim 28, wherein the second computer readable storage medium hosts a plurality of pet memorials.

31. The system of claim 28, wherein the second computer readable storage medium is in electronic communication with more than one first computer readable storage mediums for hosting a plurality of pet memorials on a plurality of pet death care provider websites.

32. The system of claim 28, wherein the online memorial includes at least one recordation comprising digital media content selected from one or more of text, documents, images, photograph, photograph slideshow, video recording, audio recording, stationary graphics, animated graphics, and music.

33. The system of claim 28, wherein the pet death care provider is a veterinary clinic, vet hospice, euthanizer, mobile vet hospice, mobile euthanizer, pet insurance provider, pet crematorium or pet cemetery.
